(19) United States
(12) Patent Application Publication
(10) Pub. No.: US 2020/0267924 A1
(43) Pub. Date: Aug. 27, 2020

(54) CONTROL SYSTEM FOR AUTOMATIC MILKING INSTALLATION AND METHOD OF CONTROLLING AUTOMATIC MILKING INSTALLATION

(71) Applicant: DELAVAL HOLDING AB, Tumba (SE)

(72) Inventor: Anders HALLSTRÖM, Tumba (SE)

(21) Appl. No.: 16/083,752

(22) PCT Filed: Mar. 8, 2017
(86) PCT No.: PCT/SE2017/050222

§ 371 Date: Sep. 10, 2018

(30) Foreign Application Priority Data
Mar. 11, 2016 (SE) 1650333-6

(51) Int. Cl. A01J 5/007; A01J 7/02; A01J 7/04; G06F 3/048

(52) U.S. Cl. CPC A01J 5/007; G06F 3/048; A01J 7/04; A01J 7/02

(57) ABSTRACT

An automatic milking installation controlled by a system including: a graphical user interface enabling user interaction with the automatic milking installation via at least one display view, an imaging unit recording image data representing at least one portion of a dairy animal, the imaging unit having a transparent cover surface configured to protect an optics section of the imaging unit and through which transparent cover surface the image data are recorded, and a control unit receiving the recorded image data, and based thereon, producing a control signal for controlling functions of the automatic milking installation. The control unit further processes the recorded image data to determine a parameter indicating an amount of dirt on the transparent cover surface, and generates graphics data for presentation to the user via the graphical user interface, which includes at least one graphical element reflecting the amount of dirt on the transparent cover surface.

### THE BACKGROUND OF THE INVENTION AND PRIOR ART

The present invention relates generally to solutions for controlling automatic milking installations. More particularly the invention relates to a system according to the preamble of claim 1 and a corresponding method. The invention also relates to a computer program and a processor-readable medium.

In modern milk production, an increasing number of functions rely on image data registered via one or more cameras of a vision system. Although this is generally an efficient and reliable approach, the image registration is also associated with problems. Namely, the farm environment is relatively dirty, and over time the cameras' optical systems risk being obstructed by dirt particles. Of course, this degrades the performance, and if left unattended, a dirty lens will result in that an intended function relying on image data cannot be effected.

WO 2010/031632 shows a solution for testing a camera arranged in an automated milking system. In particular, a camera test arrangement is provided for determining the performance of a camera arranged for use in an automated milking system. The camera test arrangement includes a camera test device with means for providing a repeatable test environment for the camera. The camera test arrangement further includes image processing means for processing data obtained from the camera when arranged in the camera test device and for determining the performance of the camera. The invention provides reliable yet non-expensive means for ensuring proper functioning of the camera.

### Problems Associated with the Prior Art

Hence, a solution is known for detecting if the vision system of a milking installation needs cleaning. However, it is still a challenge to ensure that the operator remembers to actually perform the cleaning. Further, since many of the functions in a milking installation relying on image data do not forward any image data to the operator, there is no natural means for the operator to notice, or recall, that the vision system needs cleaning if, for some reason, this has been neglected.

### SUMMARY OF THE INVENTION

The object of the present invention is therefore to offer an improved solution for prompting the operator of a milking installation to keep the vision system sufficiently clean to ensure the functionality of the system.

According to one aspect of the invention, the object is achieved by the initially described system, wherein the control unit is configured to process the recorded image data to determine a parameter indicating an amount of dirt on the transparent cover surface. The control unit is further configured to generate graphics data for presentation to the user via the graphical user interface, which graphics data contain at least one graphical element reflecting the amount of dirt on the transparent cover surface.

This system is advantageous because it renders it impossible for the operator to interact with the system without being reminded to clean the cover surface of the imaging unit should this be necessary.

According to one embodiment of this aspect of the invention, the at least one graphical element is configured to express the amount of dirt on the transparent cover surface proportionally, such that a relatively small amount of dirt is expressed as one or more graphical elements of comparatively small size, number and/or high transparency, and a relatively large amount of dirt is expressed as one or more graphical elements of comparatively large size, number and/or low transparency. Thereby, the user is informed about the gravity of the contamination in an intuitive and comprehensible manner.

According to another embodiment of this aspect of the invention, if the control unit determines that the amount of dirt on the transparent cover surface is below a first threshold level, the graphics data reflect that the transparent cover surface is clean. Namely, inevitably there will always be some dirt on the transparent cover surface. However, as long as this does not influence the quality of the image data, there is no need to inform the user about the dirt.

According to yet another embodiment of this aspect of the invention, if the control unit determines that the amount of dirt on the transparent cover surface is above a second threshold level, the graphics data reflect that the transparent cover surface is highly obstructed with dirt by the control unit being configured to cause the at least one graphical element to be presented in a cyclic manner alternating between first and second phases. Here, in the first phase, the at least one graphical element blocks a relatively large proportion of information in at least one of the at least one display view; and in the second phase, the at least one graphical element blocks a relatively small proportion of the information in said at least one display view. Consequently, it becomes evident to the user that the transparent cover surface is heavily soiled; and still, it is possible to interact via the user interface.

The at least one graphical element may be presented alternatingly either in the first or second phase. However, preferably, the control unit is configured to generate the graphics data such that the at least one graphical element gradually transitions between the first and second phases, either in a stepwise manner or continuously.

According to a further embodiment of this aspect of the invention, the control unit is configured to generate the graphics data such that the at least one graphical element is superimposed on at least one first display view of the at least one display view. As a result, information in the at least one first display view is at least partially blocked from being visually inspected by the user. Hence, the impression of a dirty transparent cover surface is conveyed to the user in a highly intuitive manner. Preferably, to further enhance this impression, the at least one graphical element is arranged to mimic a number of dirt particles.

According to another embodiment of this aspect of the invention, the control unit is configured to repeatedly update the determining of the parameter indicating the amount of dirt on the transparent cover surface; and repeatedly generate updatings of the at least one graphical element based on the updated determining of the parameter indicating the amount of dirt on the transparent cover surface. In other words, if the degree of dirtiness increases, the at least one graphical element reflect this, e.g. by increasing in size and/or number and/or with decreasing transparency. Conversely, if the amount of dirt on the transparent cover surface is determined to be below the first threshold level (i.e. the typical result of manual cleaning), the graphics data reflecting that the transparent cover surface is clean, e.g. by not presenting any graphical elements. This is advantageous because the user is provided with immediate feedback on the quality of any cleaning performed.

According to yet another embodiment of this aspect of the invention, if the system comprises two or more imaging units, the control unit is configured to generate the graphics data such that the at least one graphical element is presented in the graphical user interface in a manner associating the determined amount of dirt to a specific imaging unit of said imaging units on whose transparent cover surface has been determined. For example, if an imaging unit employed at a particular milking point has a dirty transparent cover surface, the at least one graphical element is presented in a graphical user interface associated with that milking point. Naturally, this facilitates identification of the imaging unit in need of cleaning.

According to one embodiment of this aspect of the invention, the system includes a user-manipulable input member configured to receive a user command, which, when received by the control unit, temporarily prevents the at least one graphical element from being presented via the graphical user interface. Thus, for example as long as the user holds down a button, a key or activates an on-screen button on a touchscreen, he/she can obtain an unobstructed view of any payload data shown via the graphical user interface even if the transparent cover surface has been determined to be relatively dirty.

According to another aspect of the invention, the object is achieved by the method described initially, wherein the recorded image data are processed to determine a parameter indicating an amount of dirt on the transparent cover surface. Furthermore, the graphics data are generated for presentation to the user via the graphical user interface, which graphics data contain at least one graphical element reflecting the amount of dirt on the transparent cover surface. The advantages of this method, as well as the preferred embodiments thereof, are apparent from the discussion above with reference to the proposed system.

According to a further aspect of the invention the object is achieved by a computer program loadable into the memory of at least one processor, and includes software adapted to implement the method proposed above when said program is run on at least one processor.

According to another aspect of the invention the object is achieved by a processor-readable medium, having a program recorded thereon, where the program is to control at least one processor to perform the method proposed above when the program is loaded into the at least one processor.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 illustrates how an imaging unit records image data containing data representing a portion of an animal;

FIG. 2 shows a user interacting with a graphical user interface of the proposed system;

FIGS. 3-7 illustrate the graphical user interface according to embodiments of the invention; and

FIG. 8 illustrates, by means of a flow diagram, the general method according to the invention.

### DESCRIPTION OF PREFERRED EMBODIMENTS OF THE INVENTION

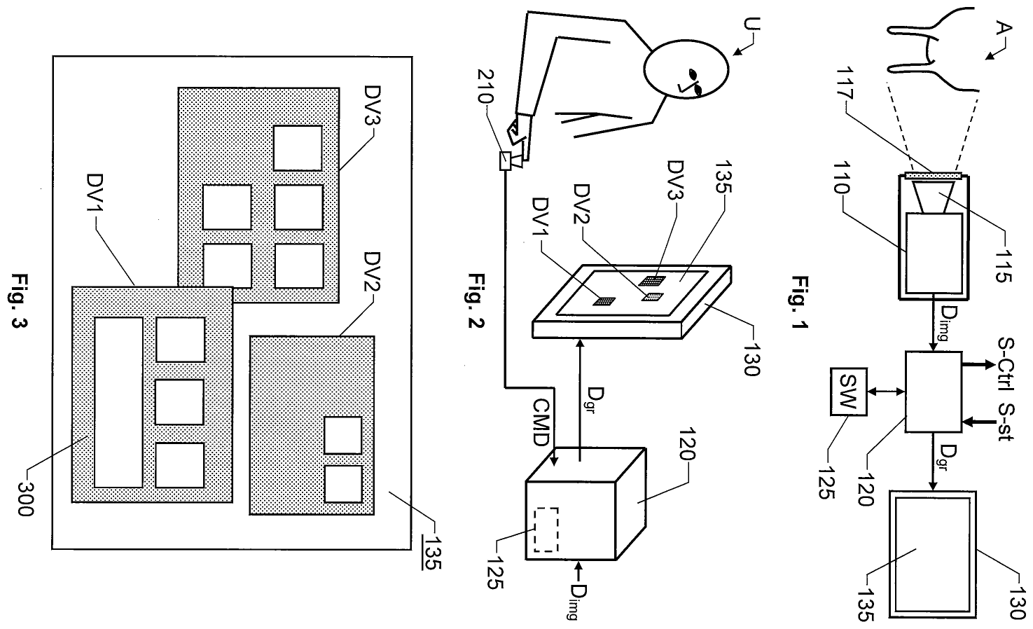

FIG. 1 illustrates how an imaging unit 110 records image data D_{img} containing data representing a portion of an animal A. Naturally, the recorded image data D_{img} inevitably contain a relatively large amount of data in addition to said data representing the portion of the animal A. For example, the recorded image data D_{img} also include data reflecting the presence of any dirt particles located within a view field of the imaging unit 110.

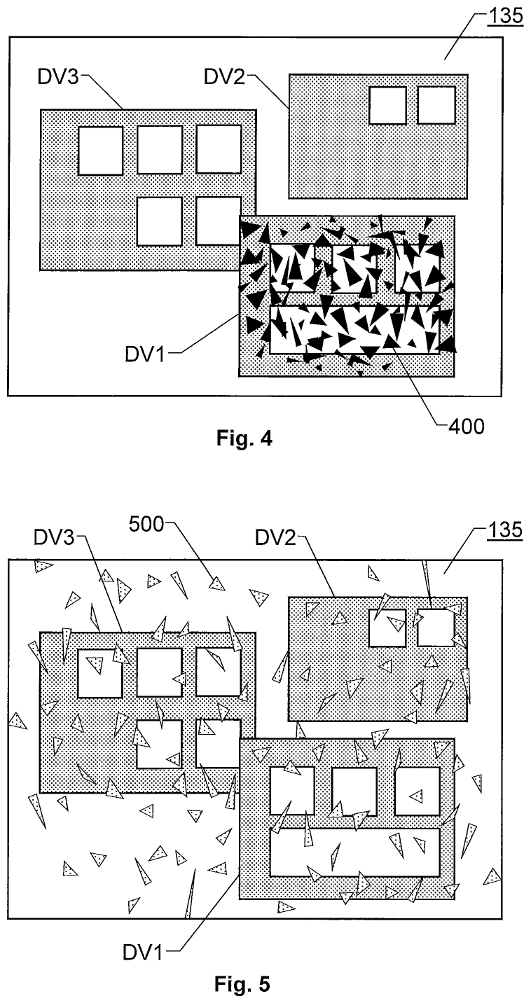

FIG. 2 shows a user U interacting with a graphical user interface 135 of the proposed system for controlling an automatic milking installation.

The graphical user interface 135 is preferably implemented by a display unit 130. The graphical user interface 135 is configured to enable the user U to interact with the automatic milking installation via at least one display view DV1, DV2 and/or DV3. In addition to the graphical user interface 135, the system includes an imaging unit 110 and a control unit 120.

The imaging unit 110 is configured to record image data D_{img} containing data representing at least one portion of a dairy animal A, say the animal's A udder and its teats. The imaging unit 110 has a transparent cover surface 117 configured to protect an optics section 115 of the imaging unit 110. The transparent cover surface 117 is transparent with respect to a range of wavelengths within which the imaging unit 110 is operative to record the image data D_{img}. For example, if the imaging unit 110 is configured to record the image data D_{img} from a first wavelength (say in the infrared part of the light spectrum) to a second wavelength (say in the ultraviolet part of the light spectrum), the transparent cover surface 117 is transparent at least with respect to a spectrum of electromagnetic energy ranging between the first and second wavelengths.

The control unit 120 is configured to receive the recorded image data D_{img}, and based thereon, produce at least one control signal S-Ctrl arranged to control at least one function of the automatic milking installation. Further, the control unit 120 is configured to process the recorded image data D_{img} to determine a parameter indicating an amount of dirt on the transparent cover surface 117. For example, the technique described in WO 2010/031632 (hereby incorporated by reference) can be used to determine the parameter in question. Additionally, the control unit 120 is configured to generate graphics data D_{gr} for presentation to the user U via the graphical user interface 135, which graphics data D_{gr} contain at least one graphical element reflecting the amount of dirt on the transparent cover surface 117.

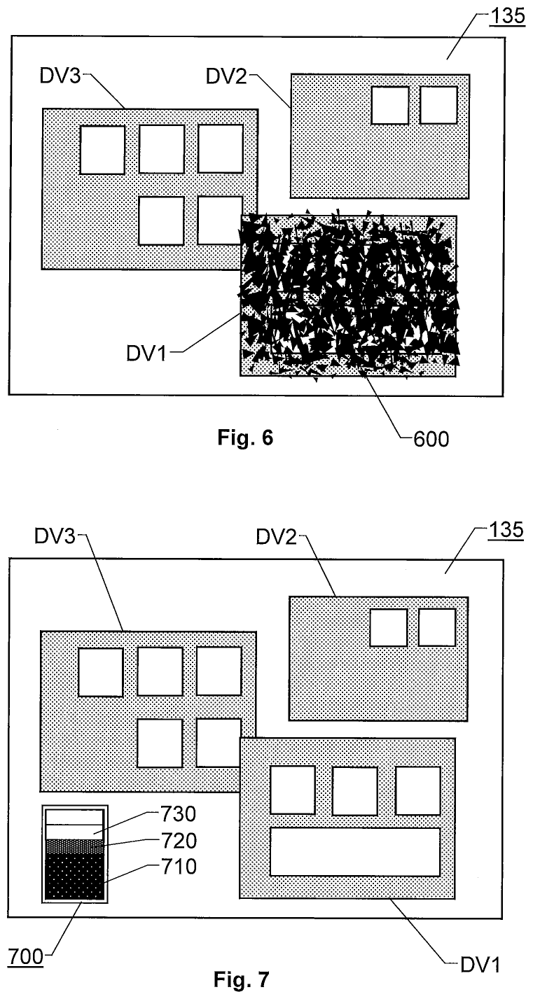

FIGS. 3-7 illustrate the graphical user interface 135 according to embodiments of the invention.

Specifically, FIG. 3 shows one example of how the graphical user interface 135 can be implemented to show display views DV1, DV2 and DV3 respectively, each of which represents a particular function of the automatic milking installation. FIG. 3 illustrates a situation where no dirt has been determined to be located on the transparent cover surface 117, or at least an amount of dirt below or equal to a first threshold level has been determined. Namely, in such a case the graphics data D_{gr} reflect that the transparent cover surface 117 is clean, e.g. by leaving a display window DV1 associated with an imaging unit 110 completely unaffected 300. In other words, the display window DV1 shows no signs of the transparent cover surface 117 being dirty.

According to one embodiment of the invention, if an amount of dirt above the first threshold level has been determined on the transparent cover surface 117, the control unit 120 is configured to generate the graphics data D_{gr} such that the graphics data D_{gr} reflect that the transparent cover surface 117 is dirty. Preferably, at least one graphical element in the graphics data D_{gr} is configured to express the amount of dirt on the transparent cover surface 117 proportionally. This means that a relatively small amount of dirt can be expressed as one or more graphical elements of comparatively small size, number, and/or high transparency, and a relatively large amount of dirt is expressed as one or more graphical elements of comparatively large size, number and/or low transparency. FIG. 4 shows an example where a comparatively large number of graphical elements 400 are included in the graphics data D_{gr} in a display window DV1 to reflect the fact that the transparent cover surface 117 is relatively dirty.

Preferably, if the automatic milking system includes two or more imaging units 110, the control unit 120 is configured to generate the graphics data D_{gr}, such that the graphical elements are presented in the graphical user interface 135 in a manner associating the determined amount of dirt to a specific imaging unit 110 of said imaging units 110 on whose transparent cover surface 117 has been determined. For example, the graphical elements 400 presented in display view DV1 of the graphical user interface 135 may indicate that the transparent cover surface 117 of a first imaging unit has a medium degree of contamination, whereas the fact that display views DV2 and DV3 do not include any obstructing graphical elements at all may indicate that any associated imaging units have clean transparent cover surface 117, or at least that the degree of contamination is below the first threshold level.

FIG. 5 shows an example where somewhat less graphical elements 500 are included in the graphics data D_{gr} to reflect the fact that the transparent cover surface 117 is somewhat less dirty. Here, the graphical elements 500 are spread out over the entire graphical user interface 135, inter alia covering display views DV1, DV2 and DV3.

In FIG. 6, we see another example, where a very large number of graphical elements 600 are included in the graphics data D_{gr} in the display view DV1 to reflect the fact that the transparent cover surface 117 is highly obstructed with dirt. Such a high density of graphical elements 600 may render it impossible for a user to extract any information from the display view DV1.

Therefore, according to one embodiment of the invention, if the control unit 120 determines that the amount of dirt on the transparent cover surface 117 is above a second threshold level, the control unit 120 is configured to cause graphical elements 600 to be presented in a cyclic manner alternating between first and second phases. In the first phase the graphical elements 600 block a relatively large proportion of information in at least one display view, say DV1; and in the second phase, the graphical elements block a relatively small proportion of the information in the display view DV1, for example as 400 in FIG. 4. Thereby, the graphics data D_{gr} can reflect that the transparent cover surface 117 is highly obstructed with dirt, and at the same time, the user U can extract information from the display view DV1 in question.

The control unit 120 may be configured to generate the graphics data D_{gr} such that the at least one graphical element is presented in either the first or the second phase in an alternating manner. Preferably, however, the control unit 120 is configured to generate the graphics data D_{gr} such that the at least one graphical element gradually transitions between the first and second phases, either stepwise, or in a continuous manner.

Especially if the transparent cover surface 117 is highly obstructed with dirt, it may be difficult for the user U to extract information via the graphical user interface 135. Preferably, therefore, the system may include a user-manipulable input member 210 for inhibiting presentation of the at least one graphical element. More precisely, the user-manipulable input member 210 is configured to forward a user command CMD (e.g. generated in response to activation of an on-screen button, a physical button or key on a keyboard) to the control unit 120. In response to the user command CMD, in turn, the control unit 120 is configured to temporarily prevent the at least one graphical element 400, 500 or 600 from being presented via the graphical user interface 135. Consequently, for example while the user U keeps an on-screen button activated, no graphical elements are shown via the graphical user interface 135.

Preferably, to enhance the user's U intuitive understanding of the degree of contamination on the transparent cover surface 117, the control unit 120 is configured to generate the graphics data D_{gr}, such that the at least one graphical element is superimposed on at least one, e.g. DV1, and the information therein is thereby at least partially blocked from being visually inspected by the user U. The at least one graphical element may either be completely opaque, or more or less transparent depending on the degree of visual obstruction desired.

Further preferably, the graphical elements 400, 500 and 600 respectively are arranged to mimic a number of dirt particles. This number is typically not equal to the number of dirt particles on the transparent cover surface 117, however it is proportional thereto as discussed above.

FIG. 7 illustrates an alternative way of indicating the amount of dirt on the transparent cover surface 117 via the graphics data D_{g}r. Here, the graphical user interface 135 includes an indicator bar 700, which designates how dirty the control unit 120 has determined the transparent cover surface 117 to be. For example, a first field 710 of the indicator bar 700 may correspond to a relatively low degree of contamination, a second field 720 of the indicator bar 700 may correspond to medium degree of contamination, and a third field 730 of the indicator bar 700 may correspond to a relatively high degree of contamination. Moreover, an intensity of the field may express more detailed information about the degree of contamination. For instance, in FIG. 7, the fact that the second field 720 has a somewhat lower intensity than the first field 710 is preferably interpreted to indicate that transparent cover surface 117 has not yet reached the medium degree of contamination.

According to one embodiment of the invention, if the control unit 120 determines that the amount of dirt on the transparent cover surface 117 is below the first threshold level, the control unit 120 is configured to generate the graphics data D_{gr} to reflect that the transparent cover surface 117 is clean, for example as in FIG. 3, i.e. where no obstructing graphical elements are included in the graphics data D_{gr}. This is beneficial, since it provides the user U with feedback as to whether or not a cleaning of the transparent cover surface 117 has been successful.

Since the contamination of the transparent cover surface 117 varies over time, or more precisely gradually increases during use of the milking installation, and is then reduced substantially in connection with cleaning, the control unit 120 is preferably configured to repeatedly update the determining of the parameter indicating the amount of dirt on the transparent cover surface 117.

Further, based on the updated determining of the parameter indicating the amount of dirt on the transparent cover surface 117, the control unit 120 is configured to repeatedly generate updatings of the graphical elements 400, 500, 600 and 700 in the graphics data D_{gr}. Thus, if the amount of dirt on the transparent cover surface 117 is determined to be below the first threshold level, the control unit 120 is configured to generate the graphics data D_{gr} such that the graphics data D_{gr} reflect that the transparent cover surface 117 is clean.

It is generally advantageous if the control unit 120 is configured to effect the above-mentioned procedure in a fully automatic manner, for instance by an executing computer program. Therefore, the control unit 120 may be communicatively connected to a memory unit 125 storing a computer program product, which, in turn, contains software for making at least one processor in the control unit 120 execute the above-described actions when the computer program product is run on the control unit 120.

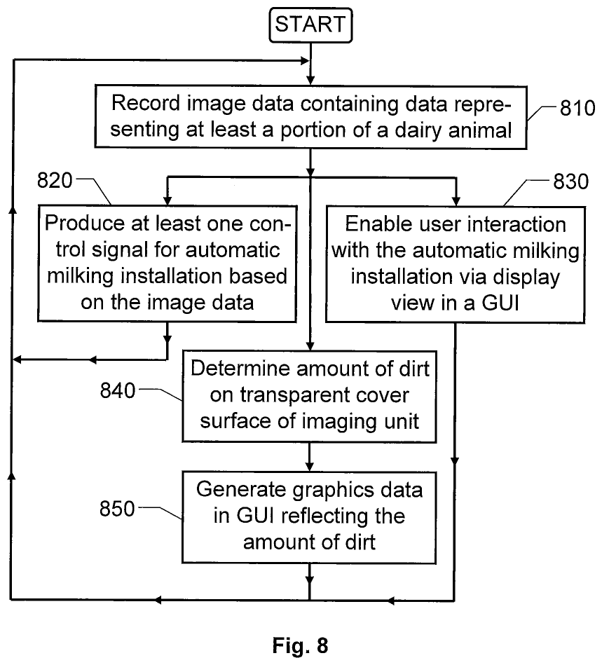

In order to sum up, and with reference to the flow diagram in FIG. 8, we will now describe the general method according to the invention for controlling an automatic milking installation.

In a first step 810, image data are recorded by means of an imaging unit. The recorded image data contain data that represent at least one portion of a dairy animal. It is further presumed that the imaging unit has a transparent cover surface that is configured to protect an optics section of the imaging unit, and through which transparent cover surface the image data are recorded.

Then, in a step 820, at least one control signal is produced based on the recorded image data. The at least one control signal is arranged to control at least one function of the automatic milking installation, for example attaching and detaching teatcups.

In a step 830, subsequent to step 810 and preferably parallel with step 820, a user is enabled to interact with the automatic milking installation via at least one display view in a graphical user interface.

After steps 820 and 830 the procedure loops back to step 810 for updated recording of the image data. However, after step 810 and preferably parallel with steps 820 and 830, in a step 840 the recorded image data are processed to determine a parameter indicating an amount of dirt on the transparent cover surface.

Thereafter, in a step 850, graphics data are generated for presentation to the user via the graphical user interface. The graphics data contain at least one graphical element reflecting the amount of dirt on the transparent cover surface, thus informing the user of any dirt on the transparent cover surface protecting the optics section of the imaging unit. Then, the procedure loops back to step 810.

All of the process steps, as well as any sub-sequence of steps, described with reference to FIG. 8 above may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Although the invention is advantageous in connection with cow milking, the invention is equally well adapted for implementation in milking machines for any other kind of mammals, such as goats, sheep or buffaloes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. A system for controlling an automatic milking installation, comprising:
a display unit (130) that presents a graphical user interface (135) for controlling the milking installation, the graphical user interface implemented as at least one display view (DV1, DV2, DV3) on the display unit, the graphical user interface (135) configured to enable a user (U) to interact with the automatic milking installation via the at least one display view (DV1, DV2, DV3);
an imaging unit (110) configured to record image data (D_{img}) comprising data representing at least one portion of a dairy animal (A), the imaging unit (110) having a transparent cover surface (117) configured to protect an optics section (115) of the imaging unit (110) and through which transparent cover surface (117) the image data (D_{img}) are recorded; and
a control unit (120) configured to
receive the recorded image data (D_{img}), and based thereon, produce at least one control signal (S-Ctrl) arranged to control at least one function of the automatic milking installation,
process the recorded image data (D_{img}) to determine a parameter indicating an amount of dirt on the transparent cover surface (117), and
where the determined parameter indicating the amount of dirt exceeds a first threshold, generate and present at least one graphics element to the user (U) via the display unit, where said at least one graphics element blocks at least a portion of the at least one display view of the graphical user interface from being viewed by the user on the display unit, in a manner corresponding to the amount of dirt on the transparent cover surface (117).

2. The system according to claim 1, wherein the at least one graphical element is displayed on the display unit in a manner that expresses the amount of dirt on the transparent cover surface (117), such that
a first amount of dirt is expressed as one or more graphical elements of any of a first size, a first quantity, and a first transparency, and
a second amount of dirt, greater than said first amount, is expressed as one or more graphical elements of any of a second size, a second quantity, and a second transparency,
where the first size is smaller than the second size, the first quantity is smaller than the second quantity, and the second transparency is less than the first transparency.

3. The system according to claim 1, wherein if the control unit (120) determines that the amount of dirt on the transparent cover surface (117) is below the first threshold level, the display unit is caused to present an indication that the transparent cover surface (117) is clean.

4. The system according to claim 1, wherein if the control unit (120) determines that the amount of dirt on the transparent cover surface (117) is above a second threshold level greater than the first threshold, the control unit causes the at least one graphical element to be presented in a cyclic manner alternating between first and second phases, such that in the first phase the at least one graphical element blocks a first proportion of the at least one display view of the graphical user interface from being viewed by the user on the display unit, and in the second phase the at least one graphical element blocks a second proportion of the at least one display view of the graphical user interface from being viewed by the user on the display unit, said first proportion being greater than said second proportion.

5. The system according to claim 4, wherein the control unit (120) is configured to generate the at least one graphics element in a manner that gradually transitions between the first and second phases.

6. The system according to claim 1, wherein the control unit (120) is configured to display the at least one graphical element as a plurality of graphical elements distributed over an entirety of the at least one display view in a manner that at least partially blocks the least one display view from being visually inspected by the user (U).

7. The system according to claim 6, wherein the plurality of graphical elements are arranged on the display unit to mimic a plurality of dirt particles atop the at least one display view of the graphical user interface.

8. The system according to claim 3, wherein the control unit (120) is configured to:
repeatedly update the determining of the parameter indicating the amount of dirt on the transparent cover surface (117), and
repeatedly generate updatings of the at least one graphical element based on the updated determining of the parameter indicating the amount of dirt on the transparent cover surface (117), whereby if the amount of dirt on the transparent cover surface (117) is determined to be below the first threshold level, the display unit is caused to present an indication indicating that the transparent cover surface (117) is clean.

9. The system according to claim 1, wherein, the system comprises two or more imaging units (110), and the control unit (120) causes the at least one graphical element (400) to be presented in the graphical user interface (135) on the display unit in a manner associating the determined amount of dirt to a specific imaging unit (110) of said imaging units (110) on whose transparent cover surface (117) has been determined.

10. The system according to claim 1, further comprising:
a user-manipulable input member (210) configured to forward a user command (CMD) to the control unit (120),
the control unit (120) being configured to, upon receiving said user command from the control unit, temporarily prevent the at least one graphical element from being displayed atop the graphical user interface (135).

11. A method of controlling an automatic milking installation, the method comprising:
providing, on a display unit, a graphical user interface (135) for controlling the milking installation, the graphical user interface implemented as at least one display view (DV1, DV2, DV3) on the display unit, the graphical user interface (135) configured to enable a user (U) to interact with the automatic milking installation;
recording image data (D_{img}), by means of an imaging unit (110), the recorded image data (D_{img}) comprising data representing at least one portion of a dairy animal (A), and the imaging unit (110) having a transparent cover surface (117) configured to protect an optics section (115) of the imaging unit (110) and through which transparent cover surface (117) the image data (D_{img}) are recorded;
producing at least one control signal (S-Ctrl) based on the recorded image data (D_{img}), the at least one control signal (S-Ctrl) being arranged to control at least one function of the automatic milking installation;
processing the recorded image data (D_{img}) to determine a parameter indicating an amount of dirt on the transparent cover surface (117); and
where the determined parameter indicating the amount of dirt exceeds a first threshold, generating and presenting to the user (U) at least one graphics element via the display unit, where said at least one graphics element blocks at least a portion of the at least one display view of the graphical user interface from being viewed by the user on the display unit, in a manner corresponding to the amount of dirt on the transparent cover surface (117).

12. The method according to claim 11, wherein the at least one graphical element is displayed on the display unit in a manner that expresses the amount of dirt on the transparent cover surface (117), such that
a first amount of dirt is expressed as one or more graphical elements of any of a first size, a first quantity, and a first transparency, and
a second amount of dirt, greater than said first amount, is expressed as one or more graphical elements of any of a second size, a second quantity, and a second transparency,
where the first size is smaller than the second size, the first quantity is smaller than the second quantity, and the second transparency is less than the first transparency.

13. The method according to claim 11, wherein if it is determined that the amount of dirt on the transparent cover surface (117) is below the first threshold level, the method comprises causing the display unit to present an indication that the transparent cover surface (117) is clean.

14. The method according to claim 11, wherein if it is determined that the amount of dirt on the transparent cover surface (117) is above a second threshold level greater than the first threshold, the method comprises causing the at least one graphical element to be presented on the display unit in a cyclic manner alternating between first and second phases, such that in the first phase the at least one graphical element blocks a first proportion of the at least one display view of the graphical user interface from being viewed by the user on the display unit, and in the second phase the at least one graphical element blocks a second proportion of the at least one display view of the graphical user interface from being viewed by the user on the display unit, said first proportion being greater than said second proportion.

15. The method according to claim 11, wherein the at least one graphical element is displayed as a plurality of graphical elements distributed over an entirety of the at least one display view in a manner that at least partially blocks the least one display view from being visually inspected by the user (U).

16. The method according to claim 15, wherein the plurality of graphical elements are arranged to mimic a plurality of dirt particles atop the at least one display view of the graphical user interface.

17. The method according to claim 13, comprising:
updating, repeatedly, the determining of the parameter indicating the amount of dirt on the transparent cover surface (117), and
generating repeated updatings of the at least one graphical element based on the updated determining of the parameter indicating the amount of dirt on the transparent cover surface (117), whereby if the amount of dirt on the transparent cover surface (117) is determined to be below the first threshold level, the display unit is caused to present an indication indicating that the transparent cover surface (117) is clean.

18. The method according to claim 11, wherein, if the system comprises two or more imaging units (110), the method comprises causing the at least one graphical element (400) to be presented in the graphical user interface (135) in a manner associating the determined amount of dirt to a specific imaging unit (110) of said imaging units (110) on whose transparent cover surface (117) has been determined.

19. The method according to claim 11, further comprising:
checking if a user command (CMD) has been received via a user-manipulable input member (210); and
upon receiving said user command from the control unit, temporarily preventing the at least one graphical element from being displayed atop the graphical user interface (135).

20. (canceled)

21. A non-transitory processor-readable medium (125), having a program recorded thereon, where the program is configured to cause a processor, upon execution by the processor, to carry out the steps of claim 11.

22. The system according to claim 1, wherein the graphical user interface is implemented as two or more display views, and the at least one graphical element is displayed as a plurality of graphical elements distributed over all of the display views of the graphical user interface in a manner that at least partially blocks all of the display views from being visually inspected by the user (U).
